(19) United States
(12) Patent Application Publication
(10) Pub. No.: US 2007/0159810 A1
(43) Pub. Date: Jul. 12, 2007

(54) Headgear light

(75) Inventor: Paul Y. Kim, Santa Ana, CA (US)

Correspondence Address: DAVID WEISS, 12650 RIVERSIDE DRIVE, SUITE 100, NORTH HOLLYWOOD, CA, 91607-3442, US

(73) Assignee: SUREFIRE, LLC, a California limited liability company

(21) Appl. No.: 11/331,779

(22) Filed: Jan. 12, 2006

(51) Int. Cl. F21V 21/084

(52) U.S. Cl. 362/105

(57) ABSTRACT

A headgear light comprising a light body removably securable to a headgear. The preferred embodiment of the light includes a mount assembly including a docking base that is removably attachable to a side of a helmet or other headgear, and provides visible light, invisible light, and friend-or-foe light signals. The light body is compact for easy storage and handling, and can be quickly and easily installed on and removed from the headgear with one hand and without visual reference.

### BACKGROUND OF THE INVENTION

The present invention pertains to mountable light assemblies and more particularly to a light that may be removably secured to a headgear such as a helmet.

Lights mounted on helmets and headgear have been known and used in many different forms. Examples of helmet-mounted lights include patents to: Malm, U.S. Pat. No. 4,092,704; Johnston, U.S. Pat. No. 4,186,429; Barnett, U.S. Pat. No. 4,793,007; Hanabusa, U.S. Pat. No. 4,862,331; Hanabusa, U.S. Pat. No. 4,901,210; Becker, U.S. Pat. No. 5,408,393; Case, U.S. Pat. No. 5,608,919; Fischer et al., U.S. Pat. No. 6,439,733 B1; Fischer et al., U.S. Pat. No. 6,648,489 B2; and Appiah, U.S. Pat. No. 6,752,510 B1. These patents teach a visible light in combination with a helmet or headgear. The inventions disclosed in these patents have various operational characteristics and require varying degrees of effort to remove or install the lights.

A clamp that mounts on the brim of a helmet is shown in U.S. Pat. No. 5,331,684 to Baril et al. One end of this clamp is made for attachment to the front of a standard army issue helmet and the other end of this clamp is made to accept standard issue night vision goggles. A device for mounting night vision goggles on a helmet is also shown in U.S. Pat. No. 4,689,834 to McCarthy et al.

What is needed and has not been found in the prior art or the foregoing patents, however, is a helmet or other headgear-mountable light that can be rigidly attached to the helmet or other headgear and includes a light body that can be readily removed or installed with one hand in a substantially continuous motion. Also not taught in the prior art is the ability to complete such installation and removal without visual reference while the helmet or headgear is being worn. There has also been a need for a helmet or other headgear in combination with a light that provides visible light, invisible light, and/or Identify Friend or Foe (“IFF”) light. Side mounting capability in combination with invisible light and/or IFF light is also not taught in the prior art. Also not taught in the prior art is such a combination that is small enough so that the light body can be readily manipulated with one hand and stored in a pants or shirt pocket.

### SUMMARY OF THE INVENTION

According to an aspect of the present invention, a helmet or headgear-mounted light includes a mount assembly and a light body. The light body provides one or more of the following in any combination: a visible light source, a night vision light source that may be in the visible or invisible range, and/or an IFF light source. In a preferred embodiment, the helmet to be used is standard government-issue to the armed forces. The mount assembly is designed to be securely attached to the brim of the helmet with the light sources facing generally forward. This enables the present invention to be mounted on the side of the helmet or headgear or in some other location where it will not interfere with other helmet-mounted devices such as night-vision goggles.

In the preferred embodiment, the light body includes a battery housing for a battery comprising at least one battery cell for supplying power as needed to energize the light sources.

According to a preferred embodiment of the present invention, the visible light source has three levels of intensity allowing the user to illuminate the area being faced with different levels of brightness. Depending upon the tactical situation, it may be desirable to use low levels of light for navigation purposes or for investigating dark areas without necessarily compromising security. In other situations, in which user security is not a consideration, higher levels of brightness may be used to illuminate areas that may conceal hazardous conditions.

A night vision light source, such as invisible infrared or visible red, can be used for area illumination in situations where night vision capability must be maintained and where night vision devices and/or infrared capable cameras may be in use.

In the preferred embodiment, the IFF light can be a blinking green LED with a predetermined repetition rate. In hostile environments where reliable audible communication is not feasible, the flashing green light signals the presence of an individual whose identity is that of a “friend,” assuming that the signaling device has not fallen into hostile hands. Alternatively, the IFF light can be infrared or other invisible light.

In the preferred embodiment, the mount assembly includes a mounting bracket, mounting screws, a docking base, and a resilient pad. The docking base serves as a quick-release platform upon which the light body can be quickly and rigidly attached and quickly removed. The mounting screws secure the docking base to the mounting bracket. In an alternative embodiment, the mounting screws secure the mounting bracket to the helmet or headgear.

The docking base includes attachment channels that engage complementary attachment rails that are part of the light body. The docking base also includes a quick-release lever that has a latch and a quick-release button. The latch engages a catch or slot on the light body to keep the light body attached to the docking base.

When a user depresses the quick-release button, the latch is disengaged from the slot, thereby allowing the light body to be removed from the docking base by a simple sliding motion. The quick-release lever is resilient and the latch is preferably tapered, so that together they act to allow the latch to automatically reengage the catch when the light body is slid back onto the docking base.

The light body typically includes a visible light source, a night vision light source, and an IFF light source. The night vision light source preferably provides light such as invisible infrared, but may instead be a visible red light that is compatible with night vision devices while providing low level area illumination. In the preferred embodiment, LED's are the light sources because of their low power consumption and long life. The visible light source and the night vision light source are typically controlled by a single three-position switch that either activates (1) only visible lighting, (2) only night vision lighting, or (3) neither. The IFF light source is typically controlled by a separate, dedicated on/off switch. The light body of the preferred embodiment is also provided with a brightness control for varying the brightness of the visible light.

Accordingly, a light according to a preferred embodiment of the present invention comprises: a mount assembly removably attachable to a headgear such as a helmet, the mount assembly including a docking base adapted to lockably engage a light body; and a light body adapted to lockably engage the docking base, the light body including at least one light source.

According to another aspect of the present invention a preferred light embodiment comprises: a mount assembly removably attachable to a headgear and including a docking base; a light body including at least one light source; and a first attachment device carried by the docking base and a second attachment device carried by the light body, the first attachment device and the second attachment device adapted for cooperatively attaching the light body to the mount assembly when the light body is applied to the docking base and displaced in a predetermined direction with respect thereto.

According to a further aspect of the present invention, there is provided light apparatus comprising: a mount assembly removably attachable to a headgear such as a helmet and including a docking base; a light body including at least one light source; and the mount assembly and the light body adapted to be automatically locked to one another when the light body is applied to the docking base and displaced in a predetermined direction along the docking base. One of the mount assembly and the light body includes an actuator for unlocking the light body from the docking base; and the mount assembly and the light body are adapted to be detached from one another when the actuator is actuated and the light body is displaced in a direction opposite the predetermined direction along the docking base. In a preferred example, one of the docking base and the light body includes a channel and the other of the docking base and the light body includes a rail complementary to the channel for slidably engaging the light body along the docking base.

According to yet another aspect of the present invention, there is provided a light apparatus comprising: a headgear; a docking base secured to the headgear; a light body including at least one light source; and the docking base and the light body adapted to be automatically locked to one another when the light body is applied to the docking base and displaced in a predetermined direction along the docking base.

A preferred manner of practicing the present invention is provided by a method of attaching a light to a headgear, comprising: providing a headgear with a docking base; providing a light body including at least one light source; placing the headgear on a user's head; the user grasping the light body with one hand and, in a substantially continuous motion of that one hand, aligning the light body with the docking base, sliding the light body onto the docking base, and releasably locking the light body to the docking base. When the user desires to remove the light body from the headgear, the method continues by the user grasping the light body with one hand, and in a substantially continuous motion of that one hand, unlocking the light body from the docking base and sliding the light body off the docking base. The sliding and locking steps during installation of the light body to the docking base, and the unlocking and sliding steps during removal of the light body from the docking base, may be performed without visual reference by the user.

The step of providing the headgear with the docking base may include: providing a headgear; providing a mount assembly including the docking base; and securing the mount assembly to a side of the headgear. During the headgear providing step, the headgear may comprise a helmet.

### BRIEF DESCRIPTION OF THE DRAWINGS

The novel features which are characteristic of the invention, both as to structure and method of operation thereof, together with further advantages thereof, will be understood from the following description, considered in connection with the accompanying drawings, in which the preferred embodiment of the invention is illustrated by way of example. It is to be expressly understood, however, that the drawings are for illustration and description only and not as a definition of the limits or scope of the invention.

FIG. 1 is a front view of a preferred embodiment of a light assembly according to the instant invention installed on the brim of a helmet as worn by an individual;

FIG. 2 is a front view of the preferred light of FIG. 1 shown in increased scale as mounted on the brim of a helmet;

FIG. 3 is a perspective view of the preferred light embodiment of FIG. 2;

FIG. 4 is a side elevation view of a mount assembly included in the light of FIG. 2;

FIG. 5 is a sectional view of the mount assembly of FIG. 4 taken along the line 5-5 and viewed in the direction of the appended arrows;

FIG. 6 is an exploded perspective view of the docking base and resilient pad of the mount assembly;

FIG. 7 is a perspective view of the helmet mounting bracket of the mount assembly of FIG. 5;

FIG. 8 is a rear perspective view of the light body of the light of FIG. 2; and

FIG. 9 is a top view of the light of FIG. 2.

### DETAILED DESCRIPTION OF THE PREFERRED EMBODIMENT

In the following description, a specific arrangement, construction, and other details are set forth in order to provide a more thorough understanding of the instant invention. It will be apparent to those skilled in the art that the instant invention may be practiced without these specific details and that other embodiments are within the scope of the instant invention.

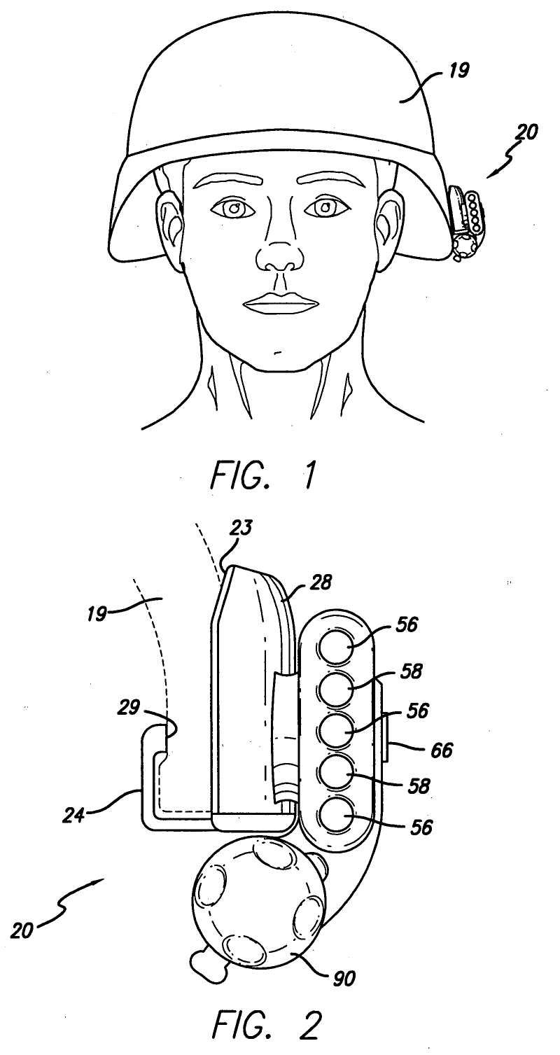

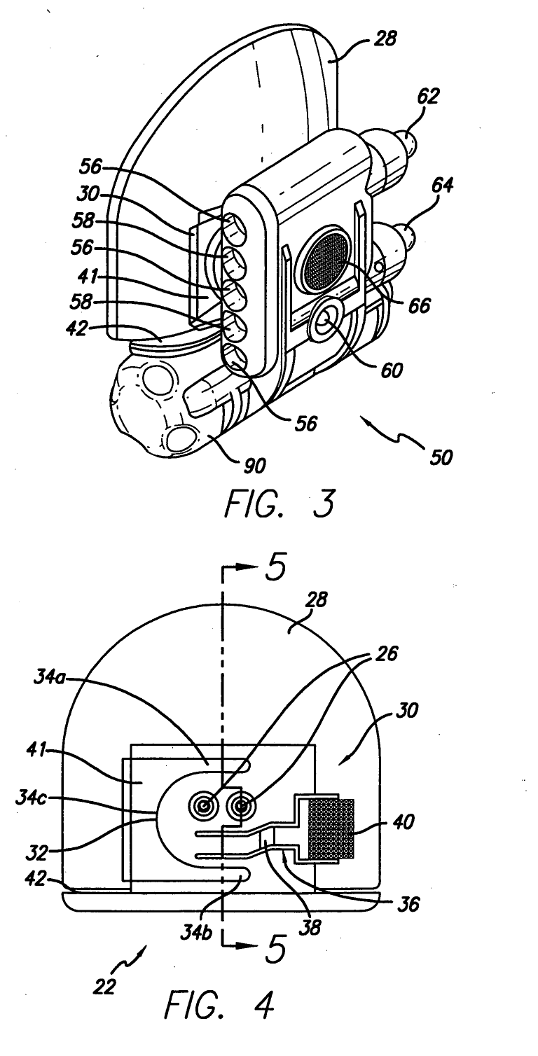

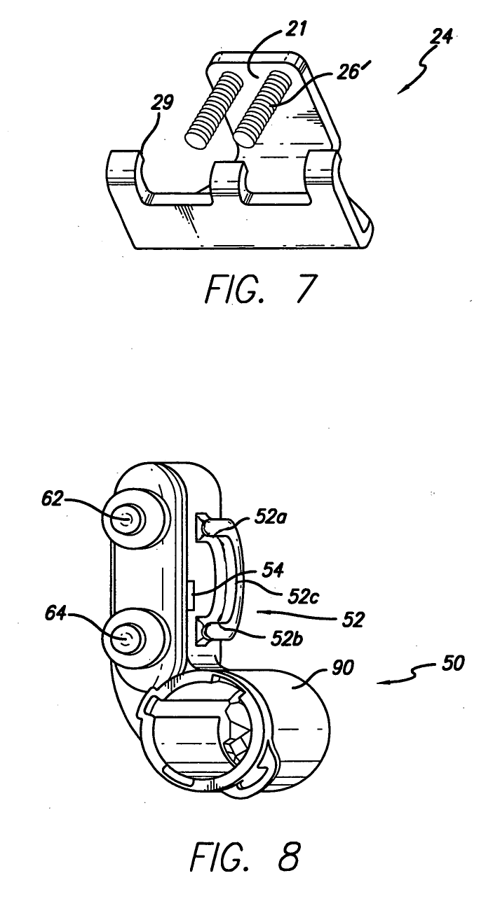

FIGS. 1-9 show a preferred embodiment of a light apparatus or light 20 of the instant invention. FIG. 1 shows an individual wearing a helmet 19 with a light 20 of the present invention mounted on the helmet. As best seen in FIGS. 4, 5, 6, and 7, the preferred embodiment of the light 20 includes a mount assembly 22 comprising a mounting bracket 24 with mounting prongs 29 spaced from an opposing plate 21, mounting screws 26 threaded through threaded apertures in the opposing plate 21, a docking base 30, and a resilient pad 28. The resilient pad 28 is preferably of an elastomeric material such as neoprene, and has a contact surface 23 that contacts the outer surface of a helmet 19 or headgear. In an alternative embodiment, the resilient pad 28 is optional and need not be included in the mount assembly 22.

FIG. 1 shows the overall size of the preferred embodiment of the light 20. In this preferred embodiment, the overall size is less than 2.5 inches by 2.5 inches by 1.5 inches. This size is well-suited for achieving an objective of the instant invention which is to provide a helmet-mountable light that can be readily installed to or removed from a helmet or other headgear with only one hand and without visual reference.

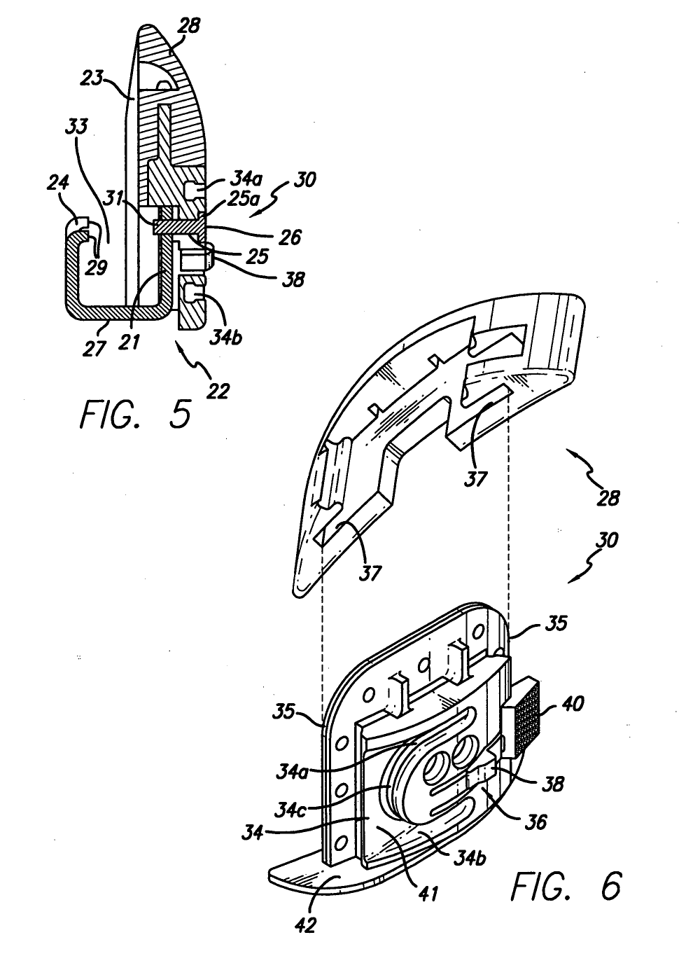

As shown in FIG. 5, in the preferred embodiment the headed attachment screws 26 attach the docking base 30 to the opposing plate 21 of the mounting bracket 24, the screws 26 extending through bores 25 in the docking base 30 with the screw heads restrained by the annular ledge of the counterbores 25a. The docking base 30 and the resilient pad 28 are secured together, with portions 35 of the docking base 30 being fitted into slots 37 in the pad 28 (FIG. 6). The screws 26 are short enough so that they do not contact the helmet 19 in this embodiment, and the gap 33 between the mounting prongs 29 and the pad contact surface 23 produces a loose fit with the helmet 19 when the mount assembly 22 is applied to the helmet 19. It may be appreciated that tightening of the screws 26 into the threaded apertures 31 of the plate 21 pulls the prongs 29 against the inner surface of the helmet 19. Further tightening of the screws 25 urges the docking base 30 and its secured resilient pad 28 inwardly toward the helmet 19, compressing the secured resilient pad 28 against the outer surface of the helmet 19 and clamping the helmet 19 between the prongs 29 and the pad 28. In this manner, the mount assembly 22 is securely mounted to the helmet 19 or other headgear.

To install the preferred embodiment of the mount assembly 22 on the helmet 19, a user pushes the mount assembly 22 onto the brim of the helmet 19 with the triangularly arranged bracket prongs 29 facing the inner surface of the helmet 19 and the resilient pad's contact surface 23 facing the helmet's outer surface, and with the lower bracket portion 27 facing and preferably engaging the edge of the helmet's brim. The user thereupon tightens the screws 26 as described above, securing the mount assembly including the docking base 30 to the helmet 19.

The resilient nature of the resilient pad 28 allows it to compressively fit differing helmet 19 or other headgear thicknesses, as well as to accommodate irregularities in the outer surface of the helmet 19 or other headgear. This resilient nature further enables the resilient pad 28 to conform to differing curvature due to differing mounting locations or differing sizes of helmet 19 or other headgear.

To install an alternative embodiment of the mount assembly 22 having screws 26′ that are long enough to contact the helmet 19 or headgear, the mount assembly 22 is installed by first loosening the screws 26′ until the distance between the mounting prongs 29 and the tips of the screws 26′ is large enough to clear the brim of the helmet 19. The mount assembly 22 is then pushed onto the brim of the helmet 19 with the prongs 29 facing the helmet's inner surface and the ends of the screws 26′ facing the helmet's outer surface, with the lower bracket portion 27 facing and preferably engaging the edge of the brim. The screws 26′ are then tightened until they contact the helmet's outer surface, forcing the prongs 29 against the helmet's inner surface and clamping the mount assembly 22 to the helmet 19. In this alternative embodiment, the securement function of the resilient pad 28 is decreased, and the resilient pad may be omitted from this embodiment if desired.

The docking base 30, best seen in FIGS. 4, 5, and 6, includes a first attachment device for cooperating with a second attachment device on the light body 50, for quickly and rigidly installing the light body 50 on the docking base 30 and for quickly removing the light body 50 therefrom. In the preferred embodiment, the docking base attachment device includes an attachment guide 32, an attachment channel 34, and a quick-release latching lever 36 with latch 38 and quick-release button 40. A “vertical” landing area 41 and a “horizontal” landing area 42 may also be included in the docking base 30.

The preferred attachment device of the light body 50, for rigidly attaching the light body 50 to the docking base 30, includes an attachment rail 52 on the light body 50 that engages the attachment channel 34 in the docking base 30. The attachment rail 52 comprises two parallel spaced-apart attachment rails 52a and 52b that are joined together at one end with a continuous U-shaped rail 52c and that are open at their other end.

The attachment channel 34 comprises two parallel spaced-apart attachment channels 34a and 34b joined together at one end with a continuous U-shaped channel 34c and that are closed at their other end. Once the attachment rails 52 are fully engaged with the attachment channels 34, the light body 50 is held in full engagement by the latch 38 that automatically engages a catch or slot 54 in the light body 50. Once the latch 38 has automatically engaged the slot 54, the light body 50 is in locked engagement with the docking base 30.

In the preferred embodiment, the light body 50 has a visible light source 56, e.g., a high luminous flux LED, a night vision light source 58, e.g., an invisible infrared LED or a visible red LED, and an IFF light source 60. A single three-position toggle switch 62 typically controls the visible light source 56 and the night vision light source 58. A separate switch 64 typically controls the IFF light source 60.

For security purposes, the IFF light source 60 is preferably invisible but may be of any color and may blink at any frequency or in any pattern. Such blinking constitutes an intermittent operation and the interval and duration of intermittence may be varied in any manner to achieve any desired blinking pattern.

In the preferred embodiment, a brightness control button 66 controls the brightness of the visible light source 56. Each instance of depressing the brightness button 66 activates, in fixed sequence, one of three levels in a brightness cycle, namely, low, medium, and high. The visible light source 56, night vision light source 58, and IFF light source 60 are all typically powered by a single battery, e.g., a 3 volt lithium battery, carried in the light body 50.

Once the mount assembly 22 is secured to the brim of the helmet 19, preferably along a side of the helmet 19, an individual wearing the helmet 19 can readily install the light body 50 on, or remove the light body 50 from, the mount assembly 22 in a substantially continuous one-handed motion, using the hand at the same side of the helmet on which the mount assembly 22 is mounted. An individual can complete such installation and removal of the light body 50 in total darkness without the need to make any visual contact with the light 20 or the helmet 19.

To install the light body 50 on the mount assembly 22, the light body 50 is held in one hand and the attachment rails 52 are aligned with the attachment channels 34. The battery housing 90 may assist the user in orienting the light body 50 so that the attachment rails 52 are roughly aligned with the attachment channels 34.

The U-shaped guide 32c of the attachment channels 34 acts as an automatic self-centering mechanism to ensure easy engagement of the attachment rails 52 with the attachment channels 34. This U-shaped guide 32c is large enough so that a user can locate it by feel with a single hand and without the need for visual reference or assistance. A “vertical” landing area 41 and a “horizontal” landing area 42 are both located near the U-shaped guide 32c and each such area provides a tactile reference point that can assist the user in properly aligning the attachment rails 52 with the attachment channels 34.

Once the user aligns the attachment rails 52a, 52b with the attachment channels 34a, 34b, the light body 50 can then be installed on the docking base 30 by simply pushing the light body 50 toward the quick-release button 40 (i.e., in a rearward direction) until the light body 50 can be pushed no further. The light body 50 is stopped from making contact with the quick-release button 40 because the attachment rails 52 are prevented from further movement by the presence of the U-shaped rail 52c coming into contact with the U-shaped channel 32c. The light body 50 is further stopped from making contact with the quick-release button 40 because the attachment rails 52 are prevented from further movement by the presence of the closed end of the attachment channels 32a and 32b. As the light body 50 reaches this position, the light body 50 trips the latch 38 of the resilient latching lever 36 to engage the catch or slot 54, automatically and releasably locking the light body 50 to the docking base 30.

As previously noted, the latch 38 and quick-release button 40 are both located on the quick-release latching lever 36 that is part of the docking base 30. The quick-release lever 36 is resilient so that when the quick-release lever 36 is operated, the quick-release lever 36 automatically returns toward the position it was in prior to being actuated. The latch 38 is tapered so that as the light body 50 is pushed onto the docking base 30, the light body 50 moves across the taper of the latch 38 thereby displacing the latch 38.

When the light body 50 reaches the point where the attachment rails 52 fully engage the attachment channels 34, the catch or slot 54 on the light body 50 is then in a position such that the latch 38 automatically springs into engagement with the slot 54. This engagement keeps the light body 50 rigidly attached to the docking base 30 and, in turn, the mount assembly 22. The taper of the latch 38 and the raised position of the latch 38 in its normal state can be seen in FIGS. 4 and 6.

The latch 38 is disengaged from the slot 54 by depressing the quick-release button 40 and simultaneously sliding the light body 50 in a direction away from the quick-release button 40. Depressing the quick-release button 40 causes the latch 38 to move away from the slot 54 until the latch 38 is completely clear of the slot 54. At this point, the light body 50 can be pulled free and clear of the docking base 30.

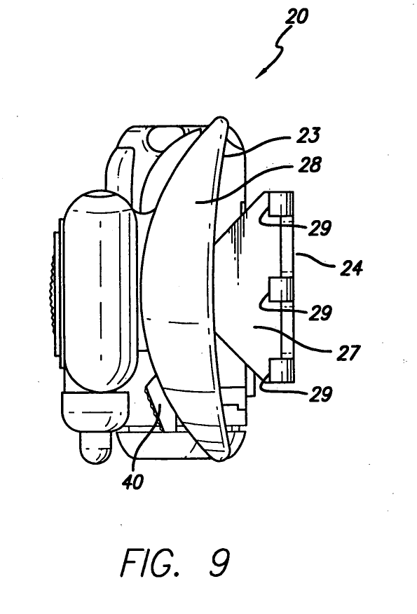

The location of the quick-release button 40 with respect to the light body 50 and mount assembly 22 is best seen in FIG. 9. It may be appreciated that, to remove the light body 50 from the docking base 30, the user may grasp the light body with one hand while, with the thumb or a finger of the same hand, simultaneously depress the quick-release button 40 and slide the light body 50 forward along the channels 34a, 34b of docking base 30 until the light body 50 is removed from the docking base 30.

The foregoing description is for illustrative purposes only. It will be apparent to those skilled in the art that various changes and modifications can be made to the instant invention without departing from the overall spirit and scope of the instant invention. It is in that context that the following claims are made.

What I claim as my invention is:

1. A light comprising:
a mount assembly removably attachable to a headgear, said mount assembly including a docking base adapted to lockably engage a light body; and
a light body adapted to lockably engage said docking base, said light body including at least one light source.

2. The light of claim 1 wherein the headgear comprises a helmet.

3. The light of claim 1 wherein said mount assembly is adapted to be securely attached to a side of the headgear.

4. The light of claim 1 wherein said mount assembly includes a bracket secured to said docking base and adapted to be attached to the headgear.

5. The light of claim 4 wherein said mount assembly includes a resilient pad secured to said docking base and engaging the headgear when said bracket is attached to the headgear.

6. The light of claim 1 wherein said at least one light source is capable of producing visible light.

7. The light of claim 1 wherein said at least one light source is capable of producing invisible light.

8. The light of claim 1 wherein said at least one light source is capable of producing intermittent light.

9. The light of claim 1 wherein said at least one light source is capable of producing visible light and invisible light.

10. The light of claim 1 wherein said at least one light source is capable of producing visible light and intermittent light.

11. The light of claim 1 wherein said at least one light source is capable of producing invisible light and intermittent light.

12. The light of claim 1 wherein said at least one light source is capable of producing visible light, invisible light and intermittent light.

13. The light of claim 6 wherein said light body includes a control for varying the brightness of the visible light.

14. The light of claim 1 wherein said docking base includes channels and a latch for lockably engaging said light body.

15. The light of claim 14 wherein said light body includes rails and a catch for cooperating with said channels and said latch for effecting the lockable engagement.

16. The light of claim 15 wherein said channels and rails are adapted to be self-centering with respect to one another.

17. The light of claim 15 wherein said channels and said rails are U-shaped.

18. The light of claim 17 wherein said docking base includes a latching lever for automatically locking said light body to said docking base when said rails are fully engaged with said channels.

19. The light of claim 18 wherein said lever is depressible for unlocking the locked engagement of said light body from said docking base.

20. The light of claim 1 wherein said at least one light source is capable of producing IFF signals.

21. The light of claim 6 wherein said at least one light source is capable of producing IFF signals.

22. The light of claim 7 wherein said at least one light source is capable of producing IFF signals.

23. The light of claim 9 wherein said at least one light source is capable of producing IFF signals.

24. The light of claim 1 wherein said at least one light source is capable of producing night vision light.

25. Light apparatus comprising:
a mount assembly removably attachable to a headgear and including a docking base;
a light body including at least one light source;
a first attachment device carried by said docking base and a second attachment device carried by said light body, said first attachment device and said second attachment device adapted for cooperatively attaching said light body to said mount assembly when said light body is applied to said docking base and displaced in a predetermined direction with respect thereto.

26. The light apparatus according to claim 25, wherein:
the headgear comprises a helmet.

27. The light apparatus according to claim 25, wherein:
said mount assembly includes a mounting bracket secured to said docking base and removably securable to the headgear.

28. The light apparatus according to claim 25, wherein:
one of said first attachment device and said second attachment device includes an actuator for releasing said light body from said mount assembly when actuated and said light body is displaced with respect to said docking base in a direction opposite said predetermined direction.

29. The light apparatus according to claim 25, wherein:
one of said first and second attachment devices includes a channel and the other of said first and second attachment devices includes a rail for cooperating with said channel when said light body is applied to said docking base and displaced in said predetermined direction.

30. Light apparatus comprising:
a mount assembly removably attachable to a headgear and including a docking base;
a light body including at least one light source; and
said mount assembly and said light body adapted to be automatically locked to one another when said light body is applied to said docking base and displaced in a predetermined direction along said docking base.

31. The light apparatus according to claim 30, wherein:
the headgear comprises a helmet.

32. The light apparatus according to claim 30, wherein:
one of said mount assembly and said light body includes an actuator for unlocking said light body from said docking base; and
said mount assembly and said light body are adapted to be detached from one another when said actuator is actuated and said light body is displaced in a direction opposite said predetermined direction along said docking base.

33. The light apparatus according to claim 30, wherein:
one of said docking base and said light body includes a channel and the other of said docking base and said light body includes a rail complementary to said channel for slidably engaging said light body along said docking base.

34. Light apparatus comprising:
a headgear;
a docking base secured to said headgear;
a light body including at least one light source; and
said docking base and said light body adapted to be automatically locked to one another when said light body is applied to said docking base and displaced in a predetermined direction along said docking base.

35. The light apparatus according to claim 34, wherein:
said headgear comprises a helmet.

36. The light apparatus according to claim 34, wherein:
one of said docking base and said light body includes an actuator for unlocking said light body from said docking base; and
said docking base and said light body are adapted to be detached from one another when said actuator is actuated and said light body is displaced in a direction opposite said predetermined direction along said docking base.

37. The light apparatus according to claim 34, wherein:
one of said docking base and said light body includes a channel and the other of said docking base and said light body includes a rail complementary to said channel for slidably engaging said light body along said docking base.

38. A method of attaching a light to a headgear, comprising:
providing a headgear with a docking base;
providing a light body including at least one light source;
placing the headgear on a user's head;
the user grasping the light body with one hand and, in a substantially continuous motion of that one hand,
aligning the light body with the docking base,
sliding the light body onto the docking base, and
releasably locking the light body to the docking base.

39. The method of claim 38, wherein:
during the headgear placing step, the docking base is positioned to a side of the user.

40. The method of claim 38, wherein the aligning step is performed without visual reference by the user.

41. The method of claim 38, wherein the sliding and locking steps are performed without visual reference by the user.

42. The method of claim 38, wherein the light body includes a battery housing, and the aligning step includes the user tactually using the battery housing to orient the light body with respect to the docking base.

43. The method of claim 38, further including:
the user grasping the light body with one hand and, in a substantially continuous motion of that one hand,
unlocking the light body from the docking base, and
sliding the light body off the docking base.

44. The method of claim 43, wherein the unlocking and sliding steps are performed without visual reference by the user.

45. The method according to claim 38, wherein the step of providing a headgear with a docking base includes:
providing a headgear;
providing a mount assembly including the docking base; and
securing the mount assembly to a side of the headgear.

46. The method according to claim 45, wherein:
during the headgear providing step, the headgear comprises a helmet.

47. The method according to claim 46, wherein:
during the helmet placing step, the docking base is positioned to a side of the user.
